(19) United States
(12) Patent Application Publication
(10) Pub. No.: US 2025/0297641 A1
(43) Pub. Date: Sep. 25, 2025

(54) SELF-ALIGNING TAPERED ROLLER BEARING ASSEMBLY WITH NON-SPLIT HOUSING

(71) Applicant: The Timken Company, North Canton, OH (US)

(72) Inventor: Dennis Veer, Prince George (CA)

(21) Appl. No.: 19/068,592

(22) Filed: Mar. 3, 2025

Related U.S. Application Data
(60) Provisional application No. 63/567,671, filed on Mar. 20, 2024.

(51) Int. Cl. F16C 19/38; F16C 43/04

(52) U.S. Cl. CPC F16C 19/383; F16C 43/04

(57) ABSTRACT

A self-aligning tapered roller bearing assembly includes an outer ring, an inner ring, a plurality of rolling elements, and a housing. The plurality of rolling elements are situated to provide a rolling interface between the outer ring and the inner ring about a central bearing axis. The plurality of rolling elements are situated in multiple rows along the central bearing axis. The housing has an interior bearing receptacle defining a central housing axis and including a concave spherical support surface configured to tolerate misalignment between the central bearing axis and the central housing axis about a central point. An outside surface of the outer ring includes, at a central axial position thereof, a plurality of circumferentially-spaced convex spherical cogs. The housing is not split, such that the interior bearing receptacle is integral and not separable.

### BACKGROUND

This application claims priority to co-pending U.S. Provisional Patent Application No. 63/567,671, filed Mar. 20, 2024, the entire contents of which are incorporated by reference herein.

### BACKGROUND

In order to manufacture a self-aligning tapered roller bearing assembly, a cartridge containing the rolling elements and having a spherical outer surface is assembled into a corresponding spherical recess of a bearing housing by providing the housing in two pieces. Conventional two-piece housings can be split into two arcuate halves or otherwise split axially to facilitate assembly. With the two pieces separated, the cartridge is placed into the spherical recess of one of the housing pieces, and then the additional housing piece is assembled therewith, for example by screws that secure the two housing pieces. While effective, manufacturing the housing in multiple pieces is more costly, and such a housing is not as strong as an otherwise equivalent one-piece housing.

Some ball bearings have a shape factor that enables the bearing to be inserted into a one-piece housing in an orientation in which a central axis of the bearing is perpendicular to a central axis of the housing receptacle. Two diametrically opposed loading slots in the housing facilitate this assembly orientation, which is followed by a reorientation of the axis of the bearing to align the bearing and housing axes.

### SUMMARY

In one aspect, the invention provides a self-aligning tapered roller bearing assembly including an outer ring, an inner ring, a plurality of rolling elements, and a housing. The plurality of rolling elements are situated to provide a rolling interface between the outer ring and the inner ring about a central bearing axis. The plurality of rolling elements are situated in multiple rows along the central bearing axis. The housing has an interior bearing receptacle defining a central housing axis and including a concave spherical support surface configured to tolerate misalignment between the central bearing axis and the central housing axis about a central point. An outside surface of the outer ring includes, at a central axial position thereof, a plurality of circumferentially-spaced convex spherical cogs. The housing is not split, such that the interior bearing receptacle is integral and not separable.

In another aspect, the invention provides a method of assembling a self-aligning tapered roller bearing assembly. A bearing unit is provided including an outer ring, an inner ring, and a plurality of rolling elements situated to provide a rolling interface between the outer ring and the inner ring. A housing is provided including an interior bearing receptacle with a concave spherical support surface. The bearing unit is oriented along a mutual central axis with the housing and in spaced axial relationship with the housing, the bearing unit having a first rotational orientation that aligns a plurality of circumferentially-spaced convex spherical cogs on an outside surface of the outer ring with a plurality of circumferentially-spaced cutouts in the concave spherical support surface. The bearing unit is axially inserted into the interior bearing receptacle along the mutual central axis so that the plurality of circumferentially-spaced convex spherical cogs are received by the plurality of circumferentially-spaced cutouts. The bearing unit is rotated to a second rotational orientation with respect to the housing about the mutual central axis, wherein the plurality of circumferentially-spaced convex spherical cogs are out of alignment with the plurality of circumferentially-spaced cutouts such that the bearing unit is provided with spherical support about a central point by the concave spherical support surface.

### BRIEF DESCRIPTION OF THE DRAWINGS

FIG. 1 is a perspective view of a self-aligning tapered roller bearing assembly according to one embodiment of the present disclosure.

FIG. 2 is a front view of the self-aligning tapered roller bearing assembly of FIG. 1.

FIG. 3 is a rear view of the self-aligning tapered roller bearing assembly of FIG. 1.

FIG. 4 is a left side view of the self-aligning tapered roller bearing assembly of FIG. 1.

FIG. 5 is a right side view of the self-aligning tapered roller bearing assembly of FIG. 1.

FIG. 6 is a cross-section view of the view of the self-aligning tapered roller bearing assembly taken along line 6-6 of FIG. 2.

FIG. 7 is a cross-section view of the view of the self-aligning tapered roller bearing assembly taken along line 7-7 of FIG. 4.

FIG. 8 is a cross-section view of the view of the self-aligning tapered roller bearing assembly taken along line 8-8 of FIG. 4.

FIG. 9 is a detail perspective view of a top end of the self-aligning tapered roller bearing assembly with a cover plate removed to reveal a pocket in a housing thereof.

FIG. 10 is a perspective view of the tapered roller bearing assembly removed from the housing to reveal spherical portions on an outer surface of the outer ring.

FIG. 11 is a perspective view of the tapered roller bearing assembly having the outer ring removed to reveal the interior bearing components.

FIG. 12 is a perspective view of only the housing of the self-aligning tapered roller bearing assembly.

FIG. 13 is a cross-section of the housing taken along line 13-13 of FIG. 12.

FIG. 14 is a perspective view of another type of housing in which aspects of the preceding embodiment can also be used.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

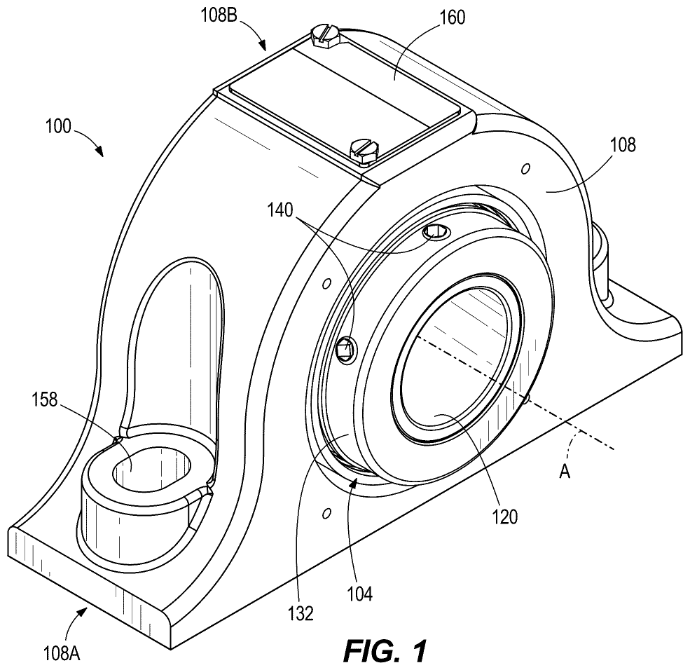

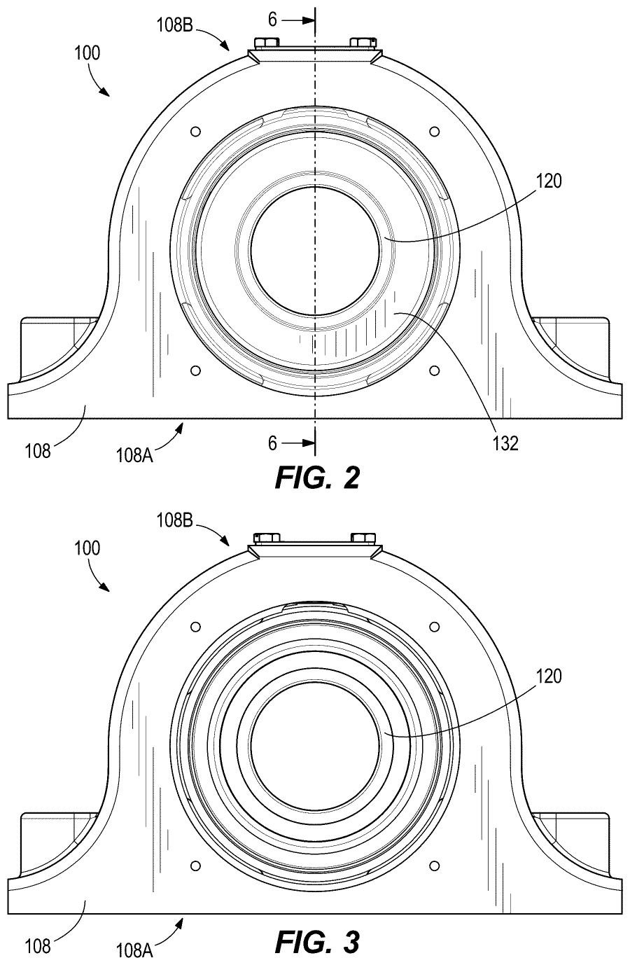

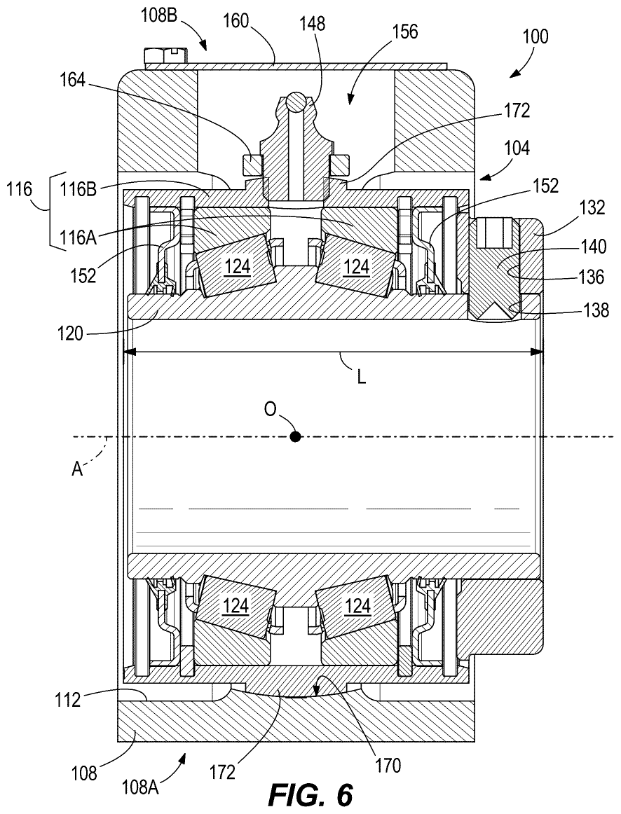

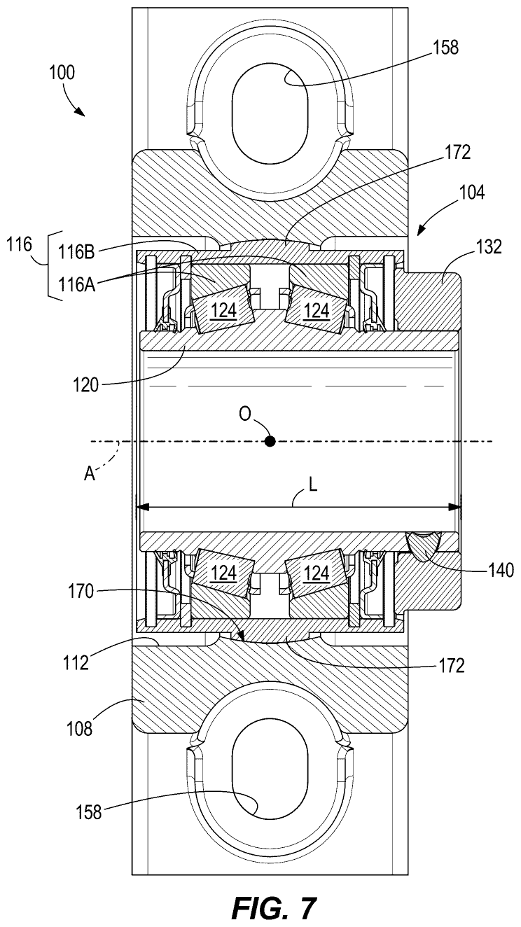

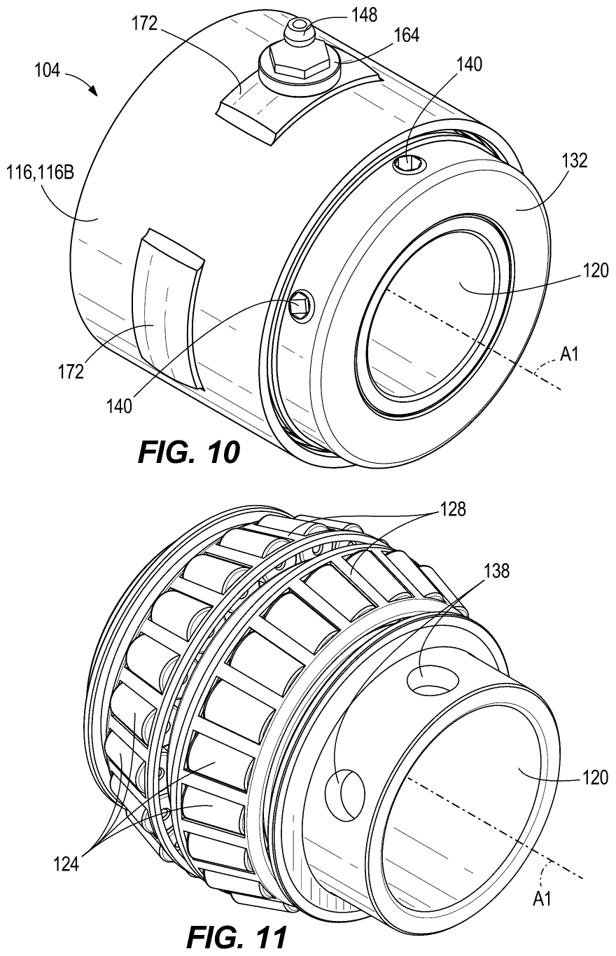

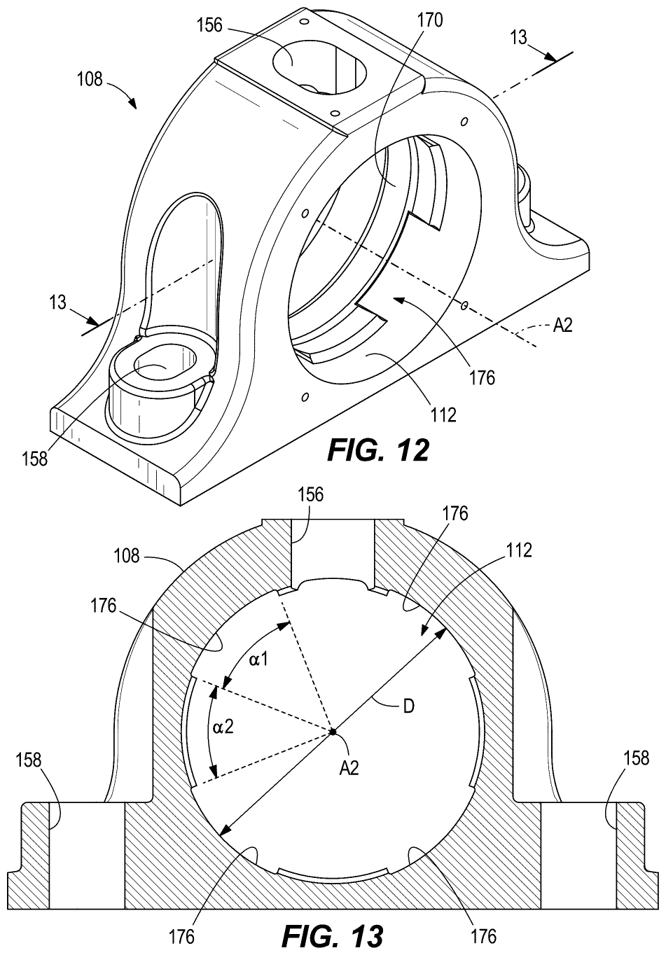

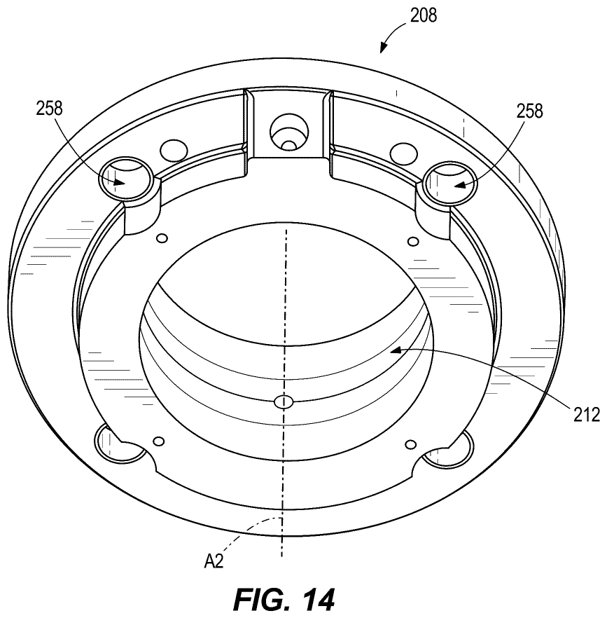

FIGS. 1-5 are exterior views of a self-aligning tapered roller bearing assembly 100 including a bearing unit 104 that is received within a housing 108. The bearing unit 104 can be a complete, sealed unit (or “cartridge”). The bearing unit 104 and an interior receptacle 112 (FIGS. 12 and 13) of the housing 108 are shown with a mutual central axis A. However, the self-aligning nature of the assembly 100 accommodates misalignment between a central bearing axis A1 (FIGS. 10 and 11) of the bearing unit 104 and a central housing axis A2 (FIGS. 12 and 13) defined by the housing receptacle 112. As described in greater detail below, the outside of the bearing unit 104 and the interior of the housing 108 define a spherical interface—although one that is intermittent and not complete. The spherical interface is self-aligning in that it freely accommodates misalignment of the axes A1, A2 about a center point O (FIGS. 6, 7), in any direction, such that a shaft (not shown) supported by the bearing assembly 100 need not be adjusted into alignment with the housing 108. Said another way, the housing 108 is only configured to maintain the bearing axis A1 in intersection with the center point O. In order to establish the interface, the bearing unit 104 must be manipulated into the housing receptacle 112, as the housing 108 is not split to accommodate assembly and disassembly.

The bearing unit 104 includes an outer ring 116, an inner ring 120, and a plurality of rolling elements 124 situated to provide a rolling interface between the outer ring 116 and the inner ring 120. Rolling element cages 128 maintain spacing between adjacent rolling elements 124 in each row or set. In the illustrated construction, as shown in at least FIGS. 6 and 7, the outer ring 116 can be assembled from two outer races 116A fixed inside an outer member 116B to provide support radially outside two separate rows or sets of rolling elements 124. The outer member 116B may also be referred to as an outer sleeve or cartridge housing. However, the invention is not limited to the particular configuration shown, and features disclosed herein can be incorporated into any number of various bearing configurations. As illustrated, the bearing unit 104 can be a dual-row tapered roller bearing (TRB) with two (or more) axially-spaced rows of tapered rolling elements 124. The inner ring 120 can be provided as a single integral piece spanning the multiple rows of rolling elements 124 of the bearing unit 104. As shown in the cross-section views of FIGS. 6 and 7, the inner ring 120 can be a dual cone inner ring that provides separate cone-shaped raceways for the separate rows of rolling elements 124, and the outer races 116A are separate cups that provide the corresponding outer raceways for the rolling elements 124.

As shown in at least FIGS. 1 and 6, a shaft coupling 132 (or “shaft collar”) is provided on an axial end of the inner ring 120. The axial end of the inner ring 120 and the shaft coupling 132 are projected outward past an adjacent axial end face 134 of the housing 108. The shaft coupling 132 includes a hole 136 that is configured for alignment with a hole 138 in the inner ring 120 to jointly receive a fastener 140 such that the fastener can engage an outer surface of a shaft (not shown) received in the inner ring 120. In some constructions, the shaft coupling 132 includes multiple holes 136 configured for alignment with multiple holes 138 in the inner ring 120 to receive respective fasteners 140. In some constructions, the fasteners 140, along with the corresponding sets of holes 136, 138 are circumferentially spaced apart (e.g., 45 degrees or more). As illustrated, the fasteners 140 are set screws, each one of which has an axial inner end configured to bite into the shaft outer surface. Each of the fasteners 140 can be externally threaded on a shank portion and in threaded engagement with internal threads of the hole 136 of the shaft coupling 132. The fasteners 140 can be adjusted (either tightened or loosened) by engagement along a radial line. For example, each fastener 140 can have a hex socket engageable by a hex or “Allen” wrench.

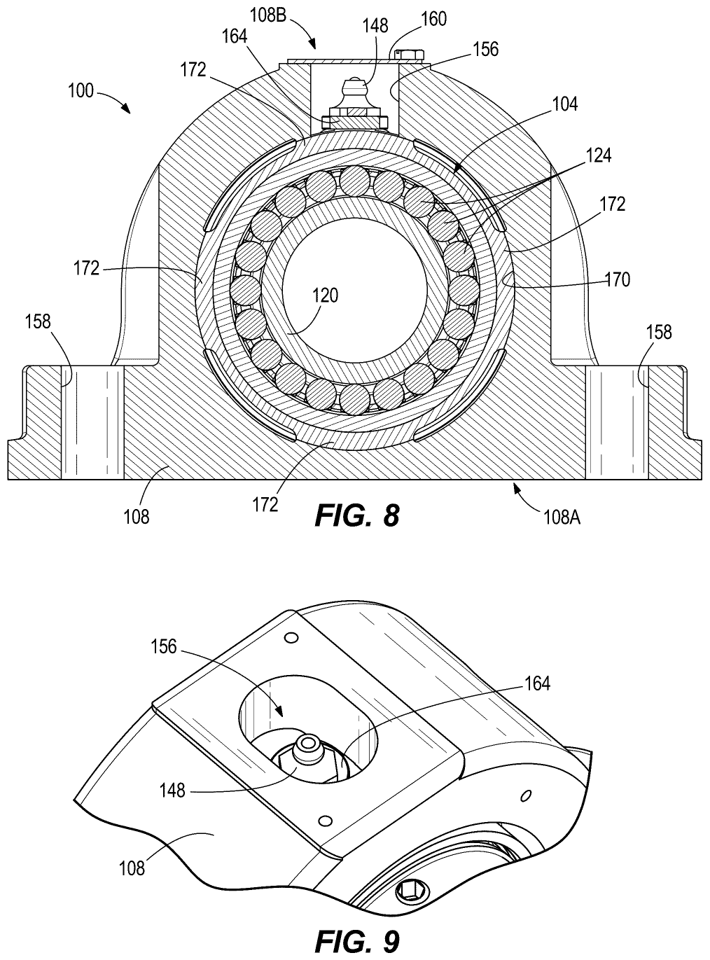

As shown in at least FIGS. 6, 8, and 9, the outer ring 116 includes a fluid fitting 148 for the insertion of lubricant into a lubricated rolling element space between the outer ring 116 and the inner ring 120. Axially outside the respective rows of rolling elements 124, the lubricated rolling element space is delimited by respective end caps or seals 152, which can take a number of physical forms. As illustrated, the seals 152 can be supported by the outer ring 116 and include deflecting seal members positioned against an outside surface of the inner ring 120. The fluid fitting 148 is received within a corresponding recess or pocket 156 of the housing 108. In the pillowblock style of housing shown, the housing 108 includes a base end 108A configured (e.g., with holes 158) for mounting to a structure and an opposite crown end 108B. The mounting holes 158 extend perpendicular to the central axis A2. As illustrated, the pocket 156 for the fluid fitting 148 is provided at the crown end 108B. A removable cover 160 may be provided to selectively close the pocket 156 and cover the fluid fitting 148 when not in use. The cover 160 can be a cover plate secured to the housing with screws as shown, although alternate configurations are optional. The fluid fitting 148 is secured to (e.g., threaded into) the outer ring 116 with a washer 164. The washer 164 has an outer diameter that is larger than the fluid fitting 148. As such, the washer 164 can contact the sidewalls (left and right sides of the pocket 156 as viewed in FIG. 8) of the pocket 156 to keep the fluid fitting 148 generally centered in the pocket 156. This also has the effect of maintaining a rotational position of the outer ring 116 within a prescribed limited angular range about the central axis A with respect to the housing 108. In some constructions, the limited angular range can be +/−5 degrees. In order to enable axial assembly of the bearing unit 104 into the housing 108, the fluid fitting 148 is installed to the outer ring 116 after the bearing unit 104 is installed to the housing 108 and properly oriented.

With reference to FIG. 7, among others, the spherical interface that tolerates angular misalignment is provided between a concave spherical support surface 170 of the receptacle 112 and corresponding convex spherical portions 172 on the outside of the bearing unit 104. In particular, the convex spherical portions 172 are formed on the outside surface of the outer ring 116. The convex spherical portions 172 are provided as a plurality of circumferentially-spaced projections, which may also be referred to as buttons or cogs. These cogs 172 share a common spherical curvature, but are not continuous around the circular periphery of the outer ring 116. Rather, each cog 172 is a separate projection from an outer base surface (e.g., cylindrical surface) on the outside of the bearing unit 104. The cogs 172 can make up approximately one-half or up to one-half (e.g., 40-50 percent, or 45-49 percent) of the circular periphery at this particular (e.g., central) axial position. In other words, the total circumferential span of all the cogs 172 is about 180 degrees or up to 180 degrees. The cogs 172 may be provided in a quantity of three or more. In the illustrated construction, a total of four spherical cogs 172 are provided. The cogs 172 are spaced evenly around the circular periphery. As such, each cog 172 has an angular span of about 45 degrees and the angular spacing between adjacent cogs 172 is about 45 degrees.

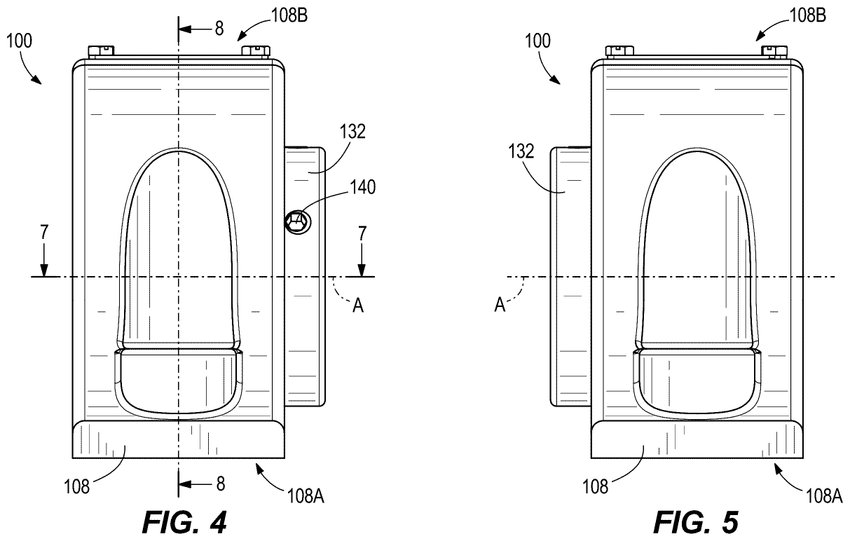

On the inside of the receptacle 112, the concave spherical support surface 170 is not fully continuous, but rather, provided with axial cutouts or access passages 176 at prescribed angular positions. As shown in FIGS. 12 and 13, the concave spherical support surface 170 can be provided with a plurality of axial cutouts 176, corresponding to the number of spherical cogs 172 on the bearing outer ring 116 (e.g., four cutouts 176 as illustrated). Corresponding to the even spacing of the spherical cogs 172 in the circumferential direction, the axial cutouts 176 can be evenly spaced (i.e., centers spaced at 360 deg. divided by the number of cutouts 176). For a total of four cutouts 176 as shown, the cutouts 176 are provided at 90-degree spacing, which can be implemented as each cutout 176 having a circumferential span α1 of about 45 degrees and adjacent cutouts 176 having about 45 degrees of angular spacing therebetween. As viewed along the central axis A2 as in FIG. 13, an angular span α1 of each of the cutouts 176 can be marginally larger (e.g., 2 to 6 degrees) than an angular span α2 of each of the remaining spherical support segments or pedestals of the surface 170 between adjacent ones of the cutouts 176. This sizing provides an assembly clearance for axial insertion of the spherical cogs 172 through the cutouts 176 to reach the axial center of the concave spherical support surface 170. The spherical cogs 172 can have an angular span that matches the angular span angular span α2 between the cutouts 176 (e.g., about 45 degrees or up to 45 degrees). The concave spherical support surface 170 can be continuous and complete but for the axial cutouts 176. The concave spherical support surface 170 is bisected by a center plane (8-8 in FIG. 4) of the housing 108, and the axial cutouts 176 can be provided on only one or both sides of the center plane. FIG. 12 illustrates the axial cutouts 176 provided on only one side of the center plane, such that the bearing unit 104 is only insertable from one axial side of the housing 108.

The construction of the spherical interface, while limiting the total surface contact between the concave spherical support surface 170 and the outer ring 116 to less than 360 degrees about the mutual central axis A (and in particular, 180 degrees or less), enables the housing 108 and the interior bearing receptacle 112 thereof to be integral and thus, continuous about the full circumference around the central axis A2. In other words, the housing 108 and the interior bearing receptacle 112 thereof are not split or divided into multiple pieces. As described in further detail below, the bearing unit 104 can be maintained co-axial with the housing 108 throughout assembly, despite the housing 108 not being split. Thus, the overall axial length L (FIGS. 6 and 7) of the bearing unit 104 is not a limiting factor and spherical bearing support may be provided to a bearing unit of any axial length. In some constructions, the overall axial length L of the bearing unit 104 exceeds the nominal diameter D (FIG. 13) of the receptacle 112 in the housing 108, which may be defined between two diametrically-opposed cutouts 176.

To assemble the bearing unit 104 with the housing 108, the following steps are taken. The bearing unit 104 and the housing 108 are provided, in accordance with any of the features described above. The bearing unit 104 is oriented along a mutual central axis A with the housing 108 and in spaced axial relationship with the housing 108. The bearing unit 104 is held in a rotational orientation that aligns the spherical cogs 172 on the outside surface of the outer ring 116 with the plurality of cutouts 176 in the concave spherical support surface 170. In this orientation, the bearing unit 104 is axially inserted into the interior bearing receptacle 112 along the mutual central axis A so that the spherical cogs 172 are received by the corresponding cutouts 176. The bearing unit 104 is then rotated with respect to the housing 108 about the mutual central axis A to move the plurality spherical cogs out of alignment with the cutouts 176 such that the bearing unit 104 is provided with spherical support by the concave spherical support surface 170.

In another construction shown in FIG. 14, the bearing unit 104 (not shown) is assembled with a different style of housing 208 in which the mounting holes 258 are parallel to the central axis A2. The bearing assembly having the housing 208 is known as a piloted flange bearing. The mounting holes 258 (e.g., quantity four) can be distributed about a circumference of the housing 208. Like the housing 108 of the preceding construction, the housing 208 is not split, such that the interior bearing receptacle 212 is integral and not separable.

Although some aspects have been described in detail with reference to certain preferred embodiments, variations and modifications exist within the scope and spirit of one or more independent aspects as described. Various features and advantages of the invention are set forth in the following claims.

What is claimed is:

1. A self-aligning tapered roller bearing assembly comprising:
an outer ring;
an inner ring;
a plurality of rolling elements situated to provide a rolling interface between the outer ring and the inner ring about a central bearing axis, wherein the plurality of rolling elements are situated in multiple rows along the central bearing axis; and
a housing having an interior bearing receptacle defining a central housing axis and including a concave spherical support surface configured to tolerate misalignment between the central bearing axis and the central housing axis about a central point,
wherein an outside surface of the outer ring includes, at a central axial position thereof, a plurality of circumferentially-spaced convex spherical cogs, and
wherein the housing is not split, such that the interior bearing receptacle is integral and not separable.

2. The self-aligning tapered roller bearing assembly of claim 1, wherein the housing includes mounting holes that extend perpendicular to the central housing axis.

3. The self-aligning tapered roller bearing assembly of claim 1, wherein the housing includes mounting holes that extend parallel to the central housing axis.

4. The self-aligning tapered roller bearing assembly of claim 1, wherein the concave spherical support surface includes a plurality of circumferentially-spaced cutouts sized and arranged to allow axial passage of the plurality of circumferentially-spaced convex spherical cogs.

5. The self-aligning tapered roller bearing assembly of claim 4, wherein an overall axial length L of the bearing unit 104 exceeds a nominal diameter defined between two diametrically-opposed ones of the plurality of circumferentially-spaced cutouts of the bearing receptacle.

6. The self-aligning tapered roller bearing assembly of claim 4, wherein a total circumferential span of all the plurality of circumferentially-spaced convex spherical cogs is up to 180 degrees.

7. The self-aligning tapered roller bearing assembly of claim 4, wherein the plurality of circumferentially-spaced convex spherical cogs is a group of exactly four evenly-spaced cogs and the plurality of circumferentially-spaced cutouts is a group of exactly four evenly-spaced cutouts.

8. The self-aligning tapered roller bearing assembly of claim 4, wherein an angular span α1 of each of the plurality of circumferentially-spaced cutouts is 2 to 6 degrees larger than an angular span between adjacent ones of the plurality of circumferentially-spaced cutouts to provide an assembly clearance for axial insertion of the plurality of circumferentially-spaced convex spherical cogs.

9. The self-aligning tapered roller bearing assembly of claim 1, further comprising a fluid fitting connected to the outside surface of the outer ring, wherein the fluid fitting is received within a corresponding pocket of the housing, and a rotational allowance of the bearing unit with respect to the housing is limited by the fluid fitting within the pocket.

10. The self-aligning tapered roller bearing assembly of claim 1, wherein the multiple rows of rolling elements include two oppositely-angled rows of tapered rolling elements.

11. A method of assembling a self-aligning tapered roller bearing assembly, the method comprising:
providing a bearing unit including an outer ring, an inner ring, and a plurality of rolling elements situated to provide a rolling interface between the outer ring and the inner ring;
providing a housing including an interior bearing receptacle with a concave spherical support surface;
orienting the bearing unit along a mutual central axis with the housing and in spaced axial relationship with the housing, the bearing unit having a first rotational orientation that aligns a plurality of circumferentially-spaced convex spherical cogs on an outside surface of the outer ring with a plurality of circumferentially-spaced cutouts in the concave spherical support surface;
axially inserting the bearing unit into the interior bearing receptacle along the mutual central axis so that the plurality of circumferentially-spaced convex spherical cogs are received by the plurality of circumferentially-spaced cutouts; and
rotating the bearing unit to a second rotational orientation with respect to the housing about the mutual central axis, wherein the plurality of circumferentially-spaced convex spherical cogs are out of alignment with the plurality of circumferentially-spaced cutouts such that the bearing unit is provided with spherical support about a central point by the concave spherical support surface.

12. The method of claim 11, wherein the rotating includes rotating through a total angle of about 45 degrees between the first rotational orientation and the second rotational orientation.

13. The method of claim 11, further comprising installing a fluid fitting to the outside surface of the outer ring through a pocket in the housing, wherein the installation of the fluid fitting blocks rotation of the bearing unit to the first rotational orientation.
